(19) United States
(12) Patent Application Publication
(10) Pub. No.: US 2006/0065422 A1
(43) Pub. Date: Mar. 30, 2006

(54) Power strip safety box

(76) Inventor: Kevin Broyles, Milpitas, CA (US)

Correspondence Address: Raymond M. Galasso;Simon, Galasso & Frantz PLC, P.O. Box 26503, Austin, TX, 78755-0503, US

(21) Appl. No.: 11/046,446

(22) Filed: Jan. 28, 2005

Related U.S. Application Data
(60) Provisional application No. 60/613,348, filed on Sep. 27, 2004.

(51) Int. Cl. H01H 23/04

(52) U.S. Cl. 174/53

(57) ABSTRACT

A box assembly for concealing and holding one or two conventional power strips, peripherals and excess lengths of cables, the box comprising a box body having a front wall, a back wall, two opposing side walls, a base, and an open top portion. Box is configured with a hole on the right side and rear sized to permit a plurality of power cords and cables to enter through the wall of the box. The box is provided with an area for storage of excess lengths of power cables, network cables, transformers, etc. The box is provided with a cover having a hinged footrest portion and a latch to secure the cover in a closed position and thereby improve safety by limiting the access of small children to the box interior.

### CROSS REFERENCE TO RELATED APPLICATIONS

This application claims priority to co-pending U.S. Provisional Patent Application having Ser. No. 60/613,348 filed Sep. 27, 2004 entitled “PSS Box”, having a common applicant herewith.

### FIELD OF THE DISCLOSURE

The disclosures made herein relate generally to the field of electrical outlet safety enclosures, and more particularly to devices designed to enclose electrical power strips under desks and computer workstations so as to prevent injury to infants and children from electrical shock.

### BACKGROUND

Desks and computer works stations, as may be found in households and in offices, frequently have a plurality of electrical and electronic devices. Examples of such devices include computers, monitors, desk lamp, radio, as well as computer peripheral devices such as printers, scanners, modems, amplified speakers, MIDI devices, game controllers, etc.

It is common practice to employ a power strip having several standard power receptacle sockets to connect several electrical devices to be operated from a single electrical power source. The often used and well known power strip has, at one end, a plug for plugging into an electrical power receptacle, the opposite end having a plurality of electrical receptacles usually contained within an elongated rectangular block or power strip. The plugs from each of the electrical devices are inserted into the receptacles of the power strip and all can be used simultaneously.

Conventional and readily available power strips are typically elongated bar structures with a row of receptacles formed therein. Power strips, particularly for computer applications, may additionally include a surge protection devices and sometimes noise filters devices. While many power strips are similar in essential form, they often differ dimensionally and in cosmetic and more detailed aspects.

A limitation of the use of a power strip for providing an AC power connection point to a plurality of electronic devices under a desk or computer workstation gives rise to an undesirable disordered tangle of electrical power cables and other wires on the floor under the desk.

Another limitation is that the use of a power strip under the desk to connect these electrical power chords to the power mains places electrical receptacles and plugs on the floor directly in the zone under the desk where a child or adult will place their feet. More than being an unsightly snarl, such an arrangement puts anyone sitting at the desk or a child crawling under the desk at risk of electrical shock and physical injury.

In households having small children, unused electrical outlets are often childproofed to protect the child or infant from electrical shock. If an electrical outlet or extension cord receptacle is left exposed, curiosity driven small children can inadvertently or intentionally place insert electrically conductive objects into the outlet. Small fingers playing with metallic objects around open receptacles can make the child appear as another electrical load to the local power generating utility, placing the child or infant at the energy receiving end of the transmission grid, and placing the child's life and health in jeopardy. While minor shocks are often just painful survivable events, more serious shocks, say from fingers dampened in a child's mouth, can be fatal.

In the current art, electrical receptacles have been developed that provide some child protection features against shock. Examples include those that utilize a rotatable cap having slots that will not admit conductive material to touch the electrical contacts unless the cap is intentionally rotated against the resisting torque of its self-closing spring to bring the slots in the cap into alignment with the underlying receptacle slots. Another design uses a flat plastic plug inserted into the receptacle to block entrance to and contact with the electrical power contacts of the receptacle.

One limitation of incorporating child protection features directly on the electrical receptacle is that these prior art child proof receptacles lose their ability to protect children against shock if the receptacle has an electrical plug inserted into it, as the plug may become partially withdrawn from the receptacle, thereby exposing the plug's electrical conductors in the space between the plug and the receptacle.

Therefore, an apparatus for enclosing the snarl of electrical cords, plugs and one or more power strip receptacles as found under a desk or computer workstation, particularly one that isolated these cords, plugs and receptacles from seated operators and small children thereby removing cable clutter and providing child safety from electrical shock, as well as providing a convenient and ergonomically sloped foot rest would be useful and novel.

### SUMMARY OF THE DISCLOSURE

Accordingly, inventive disclosures made herein comprise a power strip safety box assembly.

In one embodiment, a power safety strip box assembly comprises a rectangular shaped box body size to accept one or two conventional six to 8 receptacle power strips, and sized to additionally contain and conceal plugs, wall type power transformer modules, and excess lengths of power and other communications chords such as modem chords, network cables, etc. The rectangular box body is equipment with a hinged cover to provide user access to the power strip and cables. One or more holes are provided through the sides of the power safety strip box assembly. These holes are sized to provide a suitable entrance and egress open to the power safety strip box for the electrical power chords and other cables. The hinged cover of the power safety strip box is provided with a lockable hasp or latch; so that child access to the electrical plugs and power strip contained with the box can be restricted.

A further modification of the above embodiment provides another embodiment in which the power safety strip box lid which is tilted or slanted at an approximately 30 degree angle to provide the seated user with an ergonomically sloped foot rest surface. Users can rest their feet upon the slanted surface as they sit at the desk with their feet raised up from the floor. In this embodiment, the slanted lid of the power strip safety box may be provided with a soft and non-slip covering such as a single or multi-ply sponge rubber sheet which is permanently adhered to the outside surface of the slanted lid. The soft and non-slip covering provides comfort to the user and resists the tendency of feet to slide on the slanted lid surface.

The power safety strip box assembly may be provided with at least two adjustable claws, adjustable mounted to the base of the power safety strip box assembly. The claws are size to accept and to secure one or two power strips within the power safety strip box.

Accordingly, it is a principal object of the inventive disclosure made herein to provide a novel and useful safety enclosure for one or two electrical power strips, an enclosure that protects children from accidental electrical shock.

It is another object of the inventive disclosure made herein to provide a power strip safety enclosure that when installed under a desk or computer workstation, additionally serves as an ergonomically sloped and elevated foot rest.

It is another object of the inventive disclosure made herein to provide a power strip safety box designed to reduce the clutter and tangle of electrical cords, wires and power supplies by storing and hiding these items within the power strip safety box enclosure.

It is another object of the inventive disclosure made herein to provide a low cost and easily installed power strip safety enclosure designed to accommodate well known and widely used multiple outlet power strips. Such power strips are available in multiple designs incorporating 4 to 8 outlets. Some power strips are provided with integral circuit breaker protection. Power strips as designed for computer workstation protection are frequently provides with voltage surge protection and noise filtering devices. It is an objective of the present invention to provide a power strip safety enclosure designed to accommodate the vast majority of such commonly used power strips.

It is another object of the inventive disclosure made herein to provide a power strip safety box which incorporates a lockable latching mechanism to prevent accidental access by children to the power cord plugs and sockets contained within and thereby reduce the chance of electrical shock and injury from electrical shock.

It is another object of the inventive disclosure made herein to provide a power strip safety box sloped foot rest top portion with a cushioned soft, but durable covering on the surface where a user's feet would rest.

As the present invention serves additionally as a footrest, it is a further objective of the present invention to provide a power safety strip box with slip resistant feet on the bottom of the box. These feet providing an increased resistance to movement between the box and the floor, such that the box will tend to remain in place during use and not move or walk from the location in which is was placed. Such feet can be made, for example, from molded rubber material, among others. Such molded rubber materials as the slip resistant feet may be constructed are well known and are often applied to the bottom feet of step stools designed for kitchen use, as well as chairs, etc.

It is an objective of the present invention to provide a power strip safety box having two adjustable claws provided on the interior side of the base of the box. The claws being designed to securely grasp and hold a power strip in position within the box.

These and other objects of the invention made herein will become readily apparent; upon further review of the following specification and associated drawings.

### BRIEF DESCRIPTION OF THE DRAWINGS

The drawings show a form of the invention that is presently preferred, however the invention is not limited to the precise arrangement shown in the drawings.

FIG. 1 is an isometric view (not to scale) depicting a preferred embodiment of a power strip safety box in accordance with an embodiment of the inventive disclosures made herein.

FIG. 2 is an application view (not to scale) of a power strip safety box in accordance with the inventive disclosures made herein. The power strip safety box is depicted in use under a desk or computer workstation. The seated user is demonstrating the ergonomically slanted footrest feature incorporated into the cover of the power strip safety box, in accordance with disclosures made herein.

FIG. 3 is a right side outside view (not to scale) of a preferred embodiment of a power safety strip box in accordance with the inventive disclosures made herein.

FIG. 4 is an isometric view (not to scale) of one half of a set of a adjustable claws used to hold down a power safety strip inside the power strip safety box, in accordance with the inventive disclosures made herein.

FIG. 5 is an isometric view (not to scale) of a facing set of adjustable claws in accordance with the inventive disclosure made herein.

FIG. 6 is an isometric view (not to scale) of a facing set of adjustable claws, depicting a shadow outline of a power strip retained by the claws, and depicting one embodiment of a means for adjusting the position of a least one claw relative to the opposing claw.

FIG. 7 is a plan general arrangement view (not to scale) of just the base area of a power strip safety box in accordance with the inventive disclosure made herein, depicting the cable, chord and modem storage area in relation to the box walls and the location of the claws and power strip.

### DETAILED DESCRIPTION OF THE DRAWINGS

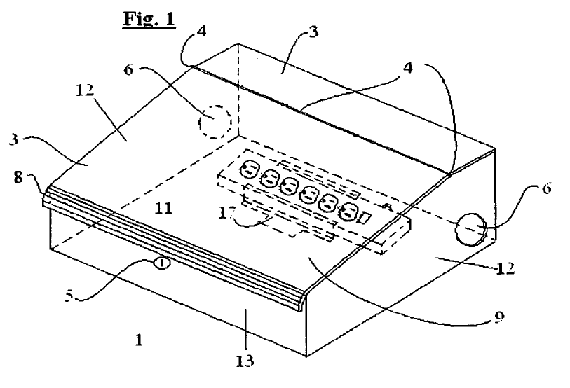

FIG. 1 depicts a power strip safety box 1 in accordance with an embodiment of the inventive disclosures made herein. The power strip safety box includes a rectangular base 11 sidewalls 11 a front wall 13 and an opposing back wall 14. The box is provided with a fixed cover member 3 having a hinged sloped footrest portion 9. The footrest portion 9 is movably attached to the cover member 3 by one or more hinge members 4, the hinges permitting the footrest portion to open generally upwards and towards the back wall of the box to provide access to the interior of the power strip safety box. The front wall 13 of the power strip safety box includes a lockable latch or hasp member 5, the lockable latch providing a means to restrict access to the power chords, plugs and receptacles contained within the interior of the power strip safety box. The side walls 12 of the box are provided with at least one power chord entry hole 6 providing an opening to the interior of the box for power chords, phone chords, spare lengths of network cables, small transformers, and other cables and computer peripherals which may be advantageously concealed within the box. Adjustable claws 17 are positioned against and retaining power strip 2. In a preferred embodiment the front edge of the sloped foot rest portion 9 is provided with a rounded front edge portion 8 to prevent bare feet from encountering a potential abrupt front edge on the cover front edge.

The power strip safety box is configured to provide a novel and useful safety enclosure for one or two electrical power strips so as to protect children from accidental electrical shock while reducing the clutter and tangle of electrical cords, wires and power supplies by storing and hiding those items within the power strip safety box. Additionally the invention provides an ergonomically sloped and elevated footrest for a seated user at workstation or desk, while removing the clutter of power chords and plugs from possible contact with the user's feet.

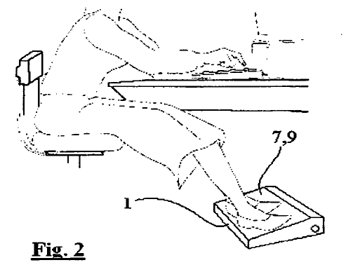

Referring now to FIG. 2, the power strip safety box in accordance with inventive disclosures made herein is positioned in use under a user's desk or computer workstation. The user's feet rest in a ergonomically comfortable position on the non-slip covering layer 7 of the sloped foot rest portion 9 of the cover member. The user's feet are comfortable raised above the floor and isolated from electrical chord contained in the power strip safety box 1 and thereby preventing the user's feet from entangling in the power chords and power strip contained within the power strip safety box.

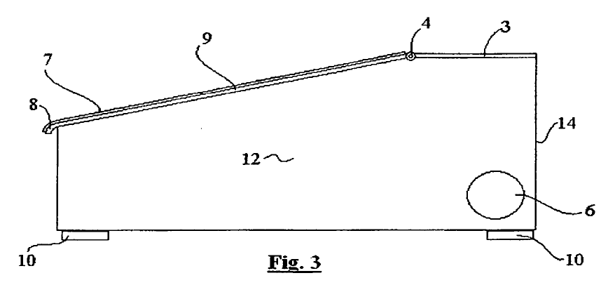

Referring now to FIG. 3, the right side of a power safety strip box in accordance with inventive disclosures made herein is depicted. Side wall 12 is provided with at least one power chord entry hole 6. Sloped cover foot rest portion 9 is movably attached to a fixed cover member 3 by at least one hinge member 4, providing a means to retainably raise and open the front portion of foot rest 9 allowing access to the interior of the power strip safety box for installation of a power strip, and stowing and connection of power chord to the power strip. A soft slip resistant cover layer 7 of foam rubber or other non-slip material is secured to the outer face of sloped footrest portion 9. In one embodiment of the inventive disclosure herein, the front edge of sloped footrest portion 9 is provided with a rounded front edge 8 to prevent the user's feet from encountering a potential abrupt edge at the lower portion of the sloped footrest portion. The power strip safety box rests on a plurality of non-slip feet 10. The non-slip-feet made of soft molded rubber or other suitable slip resistant material resists the sliding movement of the box on a possibly smooth floor surface. The presence of non-slip feet 10 to overcome a tendency of the horizontal force transmitted by the user's feet resting on the sloped cover to slide the box along the floor.

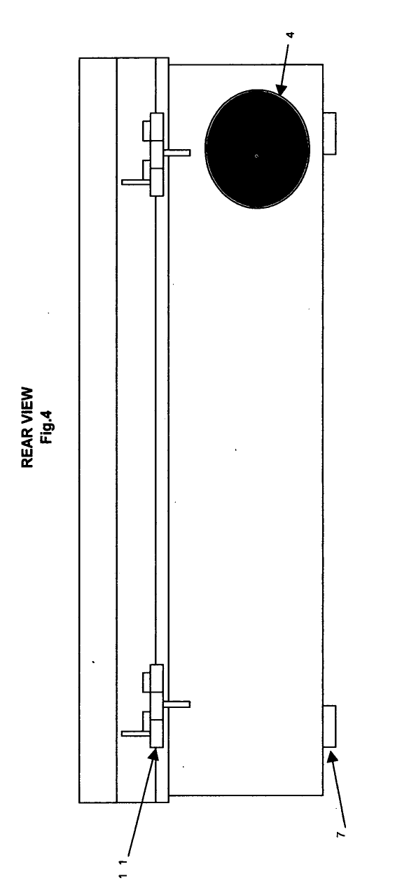

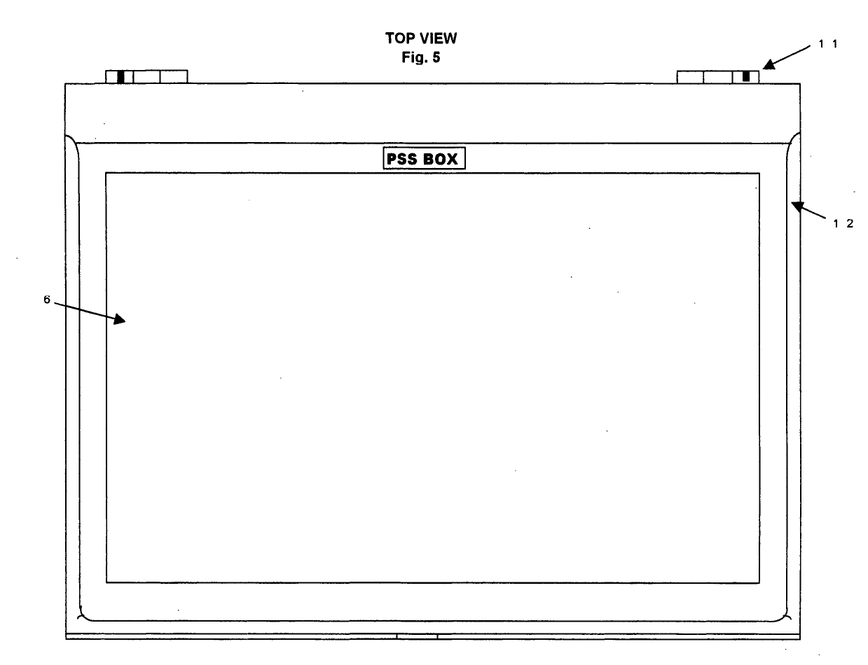

Referring now to FIGS. 4 and 5, FIGS. 4 and 5 depicts one specific embodiment of an adjustable claw for holding and retaining one or two power strips in position within the power strip safety box. Adjustable claw 17 is provided with a position adjustment slot 19 in the foot 21 of the claw. The slot is of sufficient length to allow the adjustment of the claw to hold and retain one or two side by side power strips in position. The slot is sized to receive a threaded attachment member. The claw adjusted to desired position relative to the facing claw by sliding the claw over the threaded attachment member into desired position relative to the facing claw. A retaining means for adjustably positioning and holding the claw in position 18 is threaded onto the threaded attachment member and thereby applies compressive force to frictionally hold the adjustable claw member in position. One embodiment of the threaded retaining means is a threaded wing nut, although many other embodiments may be applied as would be known to those skilled in the art.

Those skilled in the art will recognize that the depicted adjustable claw may be replaced with other designs, for example a straight claw adjusted by inserting the claw foot into one of several parallel offset slots in the base of the box, or by use of a one piece flexible claw made of flexible resilient plastic which resists deflection and thereby applies a spring force to grasp the power strip. Additionally, the claw may be optimized to reduce cost by removal of material in the center section of the part, leaving the two outside edges essentially as shown and reducing the height and material usage in the center area of the claw. Many such modifications to the adjustable claw embodiment as would be known to those skilled in the art may be made without deviating from the disclosure of the present invention.

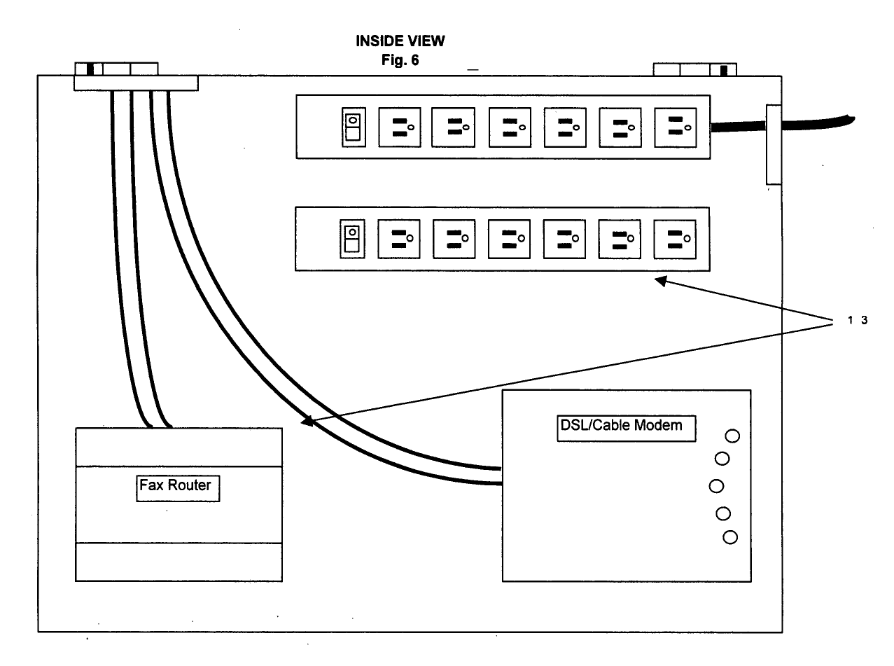

Referring now to FIG. 6, facing adjustable claws 17 are adjusted to clamp and retain a power strip 2 shown in shadow outline. A retaining means for adjustably positioning and holding the claw in position 18 applies compressive force to frictionally hold the adjustable claw member in position. In embodiments in accordance with the inventive disclosures made herein, either one claw or both claws can be adjustable. More specifically, in a specific embodiment, one claw may be fix in position while the other claw is provided as an adjustable claw, while in another embodiment both claws are provided as adjustable claws.

Referring now to FIG. 7, a plan view is depicted of the general arrangement of the base area of a power strip safety box in accordance with the inventive disclosure made herein, depicting the cable, chord and modem storage area 20 in relation to the box walls and the location of the claws 17 and one or two power strips 2.

The power strip safety box is provided with a soft pliable cushion ply over the footrest area that supports the feet. It is contemplated that materials that may be used beneficially for the cushion ply include a foam rubber sheet, a vinyl cushion stuffed with a soft pliable material such as shredded rubber or other soft material, or an upholstery fabric type stuffed mat.

It is contemplated herein that the power strip safety box as disclosed herein may be embodied in inject molded plastic, wherein the plastic housing is provided in a plurality of decorative colors, and that the colors may be chosen on order from the purchaser to match a variety of decors. It is contemplated herein that certain embodiments will be molded in multiple vibrant colors and patterns to ultimately please the user.

In one particular embodiment preferred by the inventor, the power safety strip box has dimensions of 18 inches in length across the front, by 12 inches in depth (side wall length dimension). In this particular embodiment, the footrest portion is approximately 4 inches above the base at the front of the box, and approximately 6.5 inches above the base at the back side of the box. In the preferred embodiment the fixed cover member is approximately 1.5 inches wide by 18 inches long. It should be noted that the dimensions provided herein are in no way limiting on the scope of the invention, but are provided herein to meet the disclosure and enablement requirements of the preferred embodiment so that those skilled in the art may practice the invention.

In the preceding detailed description, reference has been made to the accompanying drawings that form a part hereof, and in which are shown by way of illustration specific embodiments in which the invention may be practiced. These embodiments and certain variants thereof, have been described in sufficient detail to enable those skilled in the art to practice the invention. It is to be understood that other suitable embodiments may be utilized and that logical, material, mechanical and electrical changes may be made without departing from the spirit or scope of the invention. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A power safety strip box assembly, comprising:
a box body configured for containing and concealing a conventional electrical power strip, cables and devices, the box having an open top portion, the box comprising:
a front wall;
a back wall;
two opposing side walls, each side wall secured to a front wall and a back wall so as to form four contiguous sides of a box; and
a base secured to a bottom edge of each of the four walls, wherein at least one wall includes a hole sized to permit a plurality of power cords and cables to pass though the hole into the box;
a cover sized and fitted to conform with and completely enclose top portion of the box, the cover comprising:
a fixed cover member secured to a top edge of the side walls and to a top edge of the back wall;
a moveable footrest portion; and
a hinge member pivotally coupling the footrest portion to the fixed cover member; and
a latching member secured to a wall of the box, the latch member engaging the cover member to retain the cover member in a closed position, the latch member providing a means for reducing the chance of electrical shock by latching the cover in a closed position.

1. A power safety strip box assembly, comprising:
a box body configured for containing and concealing a conventional electrical power strip, cables and devices, the box having an open top portion, the box comprising:
a front wall;
a back wall;
two opposing side walls, each side wall secured to a front wall and a back wall so as to form four contiguous sides of a box, and
a base secured to a bottom edge of each of the four walls, wherein at least one wall includes a hole sized to permit a plurality of power cords and cables to pass though the hole into the box;
a cover sized and fitted to conform with and completely enclose top portion of the box, the cover comprising:
a fixed cover member secured to a top edge of the side walls and to a top edge of the back wall;
a moveable footrest portion; and
a hinge member pivotally coupling the footrest portion to the fixed cover member;
and a lockable latching member secured to a wall of the box, the latch member engaging the cover member to retain the cover member in a closed position, the latch member providing a means for reducing the chance of electrical shock by locking latching the cover in a closed position.

2. The power safety strip box assembly of claim 1, further comprising:
an area for storage of cables, modems, small transformers and devices.

3. (canceled)

4. The Erganizer assembly of claim 3 further comprising a non-slip cover layer secured to an outside surface of the footrest portion; and one or more slip resistant feet mounted to an outside surface of the base.

4. The power safety strip box assembly of claim 3 further comprising a non-slip cover layer secured to an outside surface of the footrest portion; and one or more slip resistant feet mounted to an outside surface of the base.

5. The Erganizer assembly of claim 4 further comprising a second power strip.

5. The power strip safety box assembly of claim 4 further comprising a second power strip.

6. (canceled)

7. (canceled)

8. The Erganizer assembly of claim 6, wherein the sloped footrest portion further includes a rounded front edge portion to remove sharp edges from a front edge of the footrest portion where a user's feet rest.

8. The power safety strip box assembly of claim 6, wherein the sloped footrest portion further includes a rounded front edge portion to remove sharp edges from a front edge of the footrest portion where a user's feet rest.

9. The Erganizer assembly of claim 8 wherein the non-slip cover layer on the footrest is selected from the group consisting of (soft rubber, foam rubber sheet, a stuffed vinyl mat, a fabric mat filled with foam rubber); and wherein the non-slip feet is selected from the group consisting of (molded rubber, adhesively attached soft rubber strip).

9. The power safety strip box assembly of claim 8 wherein the non-slip cover layer on the footrest is selected from the group consisting of (soft rubber, foam rubber sheet, a stuffed vinyl mat, a fabric mat filled with foam rubber); and wherein the non-slip feet is selected from the group consisting of (molded rubber, adhesively attached soft rubber strip).

10. The Erganizer assembly of claim 9 wherein the box body comprises molded plastic.

10. The power safety strip box assembly of claim 9 wherein the box body comprises molded plastic.

11. The Erganizer comprising:
a box body configured for containing and concealing a power strip, devices, and excess lengths of cables, the box having an open top portion, the box comprising:
a front wall nominally 18 inches wide by 4 inches high;
a back wall nominally 18 inches wide by 6 inches high;
two opposing side walls, each side wall secured to a front wall and aback wall so as to form four contiguous sides of a box, each side wall nominally 12 inches in length, each wall including a hole sized to permit 6 to 8 power chords to pass through the hole and into the box; and
a base secured to a bottom edge of each of the four walls, the base sized to form, together with the sides, a closed bottom box;
a cover sized and fitted to conform with and completely enclose the top portion of the box in a manner to reduce the chance of electrical shock and potential tangling of power cords around a seat user's feet, the cover comprising:
a fixed cover member secured to a top edge of the side walls and to a top edge of the back wall;
a movable sloped footrest portion that when closed is inclined nominally 20 degrees to the base so as to provide an ergonomically sloped foot resting surface, the cover member including a rounded front edge;
a hinge member pivotally coupling the footrest portion to the fixed cover member so that the footrest portion may be raised to provide access to the box; and
a non-slip sponge rubber cover layer secured to an outside surface of the sloped foot rest portion;
at least one slip resistant molded rubber pad secured to an outside surface of the base, the pad frictionally resisting the tendency of the box to slide along a floor when used as a foot rest;
a latching member secured to the front wall of the box, the latch member engaging the cover member to retain the cover member in a closed position, the latch member providing a means for reducing the chance of electrical shock through restricting access to the box;

11. The power strip safety box comprising:
a box body configured for containing and concealing a power strip, devices, and excess lengths of cables, the box having an open top portion, the box comprising:
a front wall nominally 18 inches wide by 4 inches high;
a back wall nominally 18 inches wide by 6 inches high;
two opposing side walls, each side wall secured to a front wall and a back wall so as to form four contiguous sides of a box, each side wall nominally 12 inches in length, each wall including a hole sized to permit 6 to 8 power chords to pass through the hole and into the box; and
a base secured to a bottom edge of each of the four walls, the base sized to form, together with the sides, a closed bottom box;
a cover sized and fitted to conform with and completely enclose the top portion of the box in a manner to reduce the chance of electrical shock and potential tangling of power cords around a seat user's feet, the cover comprising:
a fixed cover member secured to a top edge of the side walls and to a top edge of the back wall;
a movable sloped footrest portion that when closed is inclined nominally 30 degrees to the base so as to provide an ergonomically sloped foot resting surface, the cover member including a rounded front edge;
a hinge member pivotally coupling the footrest portion to the fixed cover member so that the footrest portion may be raised to provide access to the box; and
a non-slip sponge rubber cover layer secured to an outside surface of the sloped foot rest portion;
at least one slip resistant molded rubber pad secured to an outside surface of the base, the pad frictionally resisting the tendency of the box to slide along a floor when used as a foot rest;
a lockable latching member secured to the front wall of the box, the latch member engaging the cover member to retain the cover member in a closed position, the latch member providing a means for reducing the chance of electrical shock through restricting access to the box;
at least one claw attachment member secured to the base of the box;
at least one adjustable claw, wherein the claws are sized and fitted to removably secure and hold at least one power strip in position on the base, at least one claw further having a foot portion having a position adjustment slot, the slot sized to receive the attachment member, the slot sized to allow the claw to be adjusted to accommodate one or two power strips, the attachment member engaging the foot of the claw through the slot so as to provide limited movement of the claw for adjustment against the power strip; and
a retaining means to secure the adjustable claw in a desired position by engaging the attachment member.

12. (canceled)

13. (canceled)
